(19) United States
(12) Patent Application Publication
(10) Pub. No.: US 2019/0245231 A1
(43) Pub. Date: Aug. 8, 2019

(54) A METHOD OF SECURING A GAS DIFFUSION LAYER TO A CATALYST COATED MEMBRANE

(71) Applicant: UNIVERSITY OF CAPE TOWN, Cape Town (ZA)

(72) Inventors: Duarte Rui SOUSA, Surrey (CA); Nabeel HUSSAIN, Rosebank (ZA)

(21) Appl. No.: 16/343,358

(22) PCT Filed: Oct. 18, 2017
(86) PCT No.: PCT/IB2017/056468

§ 371 Date: Apr. 18, 2019

(30) Foreign Application Priority Data
Oct. 19, 2016 (GB) 1617699.2

(51) Int. Cl. H01M 8/1004; H01M 8/0273; H01M 8/0286

(52) U.S. Cl. CPC H01M 8/1004; H01M 2008/1095; H01M 8/0286; H01M 8/0273

(57) ABSTRACT

A method of securing a gas diffusion layer (GDL) to a gasketed catalyst coated membrane (CCM) is provided. The method includes positioning a double-sided adhesive film intermediate the GDL and gasket and applying pressure to the GDL and gasket to so adhere the GDL to the gasketed CCM.

### FIELD OF THE INVENTION

This invention relates to a method of securing a gas diffusion layer (GDL) to a catalyst coated membrane (CCM), more particularly a CCM having a gasket extending therefrom also known as a gasketed CCM.

### BACKGROUND TO THE INVENTION

Fuel cells can be used to generate electricity for a variety of applications including automobiles, aeroplanes and mobile communication antennae. In particular, fuel cells have been proposed as an environmentally benign alternative to internal combustion engines in automobiles. Fuel cells produce electricity by catalytically combining hydrogen and oxygen gas in a process that produces water as a side-product. A unit cell is comprised of a Membrane Electrode Assembly (MEA) positioned in between the Anode and Cathode bipolar plates. Although the amount of power generated by a single unit cell is low, combining multiple unit cells together in a fuel cell stack generates sufficient power to propel an automobile or an aeroplane. Depending on the application, fuel cell stacks typically comprise several hundred individual unit cells connected in series.

An individual MEA has a multi-layered structure. The layers are sealed together with gaskets provided between interfaces of the layers about outer perimeters thereof. The gaskets prevent gases from leaking out from a central pressurized area of the MEA called “the active area” which is where the catalytic reaction takes place. When the MEA is assembled, the various layers are compressed together in order to maximize electrical contact between the layers, minimize the overall thickness of the cell, and increase the seal of the gaskets.

The membrane electrode assembly (MEA) consists of an anode and cathode gas diffusion layer (GDL), gaskets, and catalyst coated membrane (CCM). In one typical version of a gasketed MEA, first the gaskets are applied to either side of the CCM such that the gaskets extend from the CCM about the active or catalyst coated area. This produces what is often referred to as a gasketed CCM. Then the anode and cathode GDLs are attached to opposite sides of the gasketed CCM to produce a gasketed MEA.

GDL attachment to the CCM is not trivial. Attachment is typically carried out as follows:
1. Precision application of a liquid adhesive around the border of the GDL using screen printing or pneumatic dispensing syringe on an X-Y table.
2. Placement of the GDL on the gasketed CCM.
3. Compression of the GDL to achieve intimate contact between the adhesive and the gasket.
4. Curing of the adhesive while under compression.
5. Decompressing the MEA.

The gaskets leave the active area of the CCM exposed while the GDLs are applied over the active area. The perimeter of each GDL overlaps the gasket with typically from 1 mm to 10 mm overlap. At present, the GDLs are secured to the gaskets using liquid adhesives, adhesive coating technologies, and subsequent adhesive curing processes. For example, US 2010/0000679 A1 discloses the application of the GDL to the gasketed CCM by using a liquid adhesive applied by “dot coating, line coating, dot and line coating, overall coating or any combination thereof”. These methods require the purchase of expensive liquid adhesive coating and curing equipment and entail relatively long lead times as it is required to cure the liquid adhesives for mandatory periods of time. Also, the final gasketed MEA must be subjected to liquid adhesive heat treatments that may compromise the physical properties of the gasket by causing, for example, wrinkling, folding and bending. Furthermore, as the placement and adhesion of the GDL onto the gasketed CCM is not simultaneous or instantaneous there is the potential of the GDL and CCM becoming misaligned during curing.

To improve both gas and water transport and enhance electrical contact with the catalyst layer on the CCM, a microporous layer (MPL) is often interposed between the CCM and the GDL, preferably, between the active area of the CCM and the GDL. The MPL is typically applied to the GDL and includes a carbon substrate having hydrophobic particles interspersed therein. The carbon substrate may be provided by carbon nanoparticles and the hydrophobic particles may be provided by PTFE sub-micron sized particles. This results in the MPL being a somewhat powdery layer which can affect adhesion between the GDL and CCM.

Several attempts at improving the performance or characteristics of gasketed MEAs have been published.

US 2015/0380746 A1 discloses a frame equipped membrane electrode assembly formed by joining a membrane electrode assembly (MEA) having different sizes of components together with a resin frame member. A frame shaped adhesive sheet is provided between an inner extension of the resin frame member and an outer marginal portion of the MEA. An inner marginal portion of the adhesive sheet includes an overlapped portion, which overlaps in an electrode thickness direction with the surface of an outer marginal portion of a second gas diffusion layer.

WO 2009040571 A1 discloses a membrane electrode assembly having a peripheral edge region and a central region. The membrane electrode assembly comprises an ion-conducting membrane, first and second electrocatalyst layers disposed either side of the ion-conducting membrane, and first and second gas diffusion layers disposed either side of the first and second electrocatalyst layers respectively. The membrane electrode assembly further comprises an edge protection member, the edge protection member comprising a film layer, a bonding layer, and one or more additives selected from the group consisting of free radical decomposition catalyst, self regenerating antioxidant, hydrogen donors (H-donor) primary antioxidant, free radical scavenger secondary antioxidant, oxygen absorbers (oxygen scavenger) and elemental palladium. The edge protection member is positioned between the membrane and the first and/or second gas diffusion layer at the peripheral edge region of the membrane electrode assembly, and the edge protection member overlaps the first and/or second electrocatalyst layers.

WO 2007113592 A1 discloses an assembly for use in a fuel cell, comprising an ion-conducting membrane, first and second electrocatalyst layers disposed either side of the membrane, first and second gas diffusion substrates contacting the first and second electrocatalyst layers respectively, and a first flow field plate contacting the first gas diffusion substrate. A first encapsulation film, comprising a backing layer and an adhesive layer, is positioned between edge regions of the membrane and the first gas diffusion substrate such that the adhesive layer impregnates through the thickness of the first gas diffusion substrate, and bonds the first flow field plate to the first gas diffusion layer, thereby unitising the assembly.

WO 2007113589 A1 discloses a membrane electrode assembly comprising an ion-conducting membrane, electrocatalyst layers disposed either side of the membrane and gas diffusion layers disposed adjacent to the electrocatalyst layers is disclosed. The membrane electrode assembly has an edge region and a central region and a film layer, optionally with an adhesive layer on one or both faces of the film layer, is positioned between the membrane and a gas diffusion layer at the edge region of the membrane electrode assembly. The film layer and/or, if present, the adhesive layer comprises an additive selected from the group consisting of oxygen scavengers, antioxidants or free radical scavengers.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with the invention there is provided a method of securing a gas diffusion layer (GDL) to a catalyst coated membrane (CCM) having a gasket surrounding an active area, which includes positioning a double-sided adhesive film intermediate the GDL and gasket and applying pressure to the GDL and gasket.

Further features of the invention provide for the adhesive to be pressure sensitive; for the film to be frame shaped; for the film to be removed from a sheet of material; and for the film to have a thickness of between 0.005 mm and 0.050 mm, preferably between about 0.005 mm and 0.020 mm.

Still further features of the invention provide for the film to be supplied with a release liner covering the adhesive on each side; for each release liner to be removed prior to placement of the film on the GDL and gasket respectively; and for the adhesive to be carried on either side of a carrier film.

Yet further features provide for a microporous layer (MPL) to be provided on one side of the GDL; for the adhesive film to be applied over the MPL; for heat and pressure to be applied to the GDL and adhesive film for a specified dwell time to cause the adhesive to be impregnated into the MPL; for the heat to be between 30° C. and 300° C. and the pressure between 0.01 bar and 50 bar; and for heat and pressure to be applied for between 1 second and 600 seconds.

The invention further provides a membrane electrode assembly (MEA) which includes a gas diffusion layer (GDL) and a catalyst coated membrane (CCM) having a gasket surrounding an active area of the CCM, and characterised in that the GDL is secured to the CCM by a double-sided adhesive film positioned intermediate the GDL and gasket.

Further features provide for the MEA to include an anode gas diffusion layer (GDL) and a cathode GDL secured on opposite sides of the CCM with double-sided adhesive film securing each GDL to a gasket of the CCM.

Further features of the invention provide for the double-sided adhesive film to be provided by a carrier film having an adhesive layer on each side; and for the double-sided adhesive film to have a thickness of between 0.005 mm and 0.05 mm, preferably between about 0.005 and 0.020 mm.

Still further features of the invention provide for a microporous layer (MPL) to be provided on one side of each GDL; and for the adhesive film to be applied to the MPL.

An embodiment of the invention will now be described, by way of example only, with reference to the accompanying drawings.

### BRIEF DESCRIPTION OF THE DRAWINGS

In the drawings:

FIG. 1 is a schematic illustration of an apparatus for producing a membrane electrode assembly (MEA);

FIG. 2 is a top plan view of a double-sided adhesive film;

FIG. 3 is a top plan view of a gas diffusion layer (GDL);

FIG. 4 is a top plan view of the adhesive film of FIG. 2 secured to the GDL of FIG. 3;

FIG. 5 is a top plan view of the GDL with adhesive film of FIG. 4 cut to size; and

FIG. 6 is a schematic illustration of the steps of adhering the GDL of FIG. 5 to a gasketed catalyst coated membrane (CCM).

### DETAILED DESCRIPTION WITH REFERENCE TO THE DRAWINGS

A method of securing a gas diffusion layer (GDL) to a catalyst coated membrane (CCM) having a gasket surrounding an active area, also referred to as a gasketed CCM, is provided. The method includes positioning a double-sided adhesive film intermediate the GDL and gasket and applying pressure to the GDL and gasket to so adhere the GDL.

The adhesive used in the double-sided adhesive film should preferably be pressure sensitive and may include an acrylic, natural rubber, or ethylene propylene diene monomer (EPDM) adhesive. The double-sided adhesive film may be very thin and should have a thickness of between 0.005 mm and 0.050 mm. A film with a thickness of between about 0.005 mm and 0.020 mm has been found to work well. The double-sided adhesive film typically has a laminate construction with a layer of an adhesive provided on either side of a carrier film such as a polyester film. Any suitable carrier film could be used and the carrier film could include perforations or ribs or similar features if required. For simplicity, the carrier film coated on both sides with adhesive will simply be referred to as “double-sided adhesive film”. However, the adhesive need not be carried on a carrier film and could also be provided as a uniform layer of adhesive. This could be achieved by casting or extruding the adhesive layer directly onto a release liner.

The double-sided adhesive film can be cut in any suitable manner including by punching or die cutting and laser cutting. The film can thus easily be configured to have any suitable shape and to fit any GDL and CCM combination. The cut film assembly can also be made to very fine tolerances as it is cut from a solid release liner sheet thus permitting a well-defined perimeter to be obtained.

The double-sided adhesive film will usually be cut with a frame-like shape. The inner perimeter of the frame may be complementary to the active area of the CCM while the outer perimeter of the frame may be complementary to the perimeter of the GDL. Pilot holes can be provided in the double-sided adhesive film to assist in accurately aligning it in position on the GDL.

For ease of handling, the double-sided adhesive film is supplied with a release liner covering the adhesive film on each side. These stay in place during cutting of the sheet to provide the required film shape. When the film is ready for placement on the GDL the corresponding release liner is removed and the other release liner removed when the GDL is ready for placement on the CCM.

A method of securing a GDL to a gasketed CCM may include cutting an assembly from a sheet of double-sided adhesive film with a release liner on each side. The film can be of the same construction as the tape sold as 7070 0.01 W by the Teraoka Seisakusho Company Limited. The double-sided adhesive film assembly so obtained is frame shaped and defines a central opening complementary to that of the active area of the CCM to which the GDL is to be secured. Pilot holes are also provided in the cut double-sided adhesive film assembly to facilitate precise positioning of the film assembly on the GDL.

The double-sided adhesive film assembly may be cut with larger outer perimeter dimensions than those required of the GDL to facilitate placement. Similarly, the GDL can be provided with a larger length and width than it is required to have when secured to the CCM or its net shape, which is the active area of the CCM plus the required overlap perimeter needed to secure the GDL to the gasket of the CCM.

The top release liner is then removed from the double-sided adhesive film to expose the adhesive. This is the release liner on the side of the film which will be attached to the GDL. Using the pilot holes in the film the GDL is centred above the film and then attached to it. The GDL is typically supplied with a microporous layer (MPL) on the side to be secured to the CCM so that it is interposed between the active area of the CCM and the GDL. The MPL is typically applied to the GDL and includes a carbon substrate having hydrophobic particles interspersed therein. The carbon substrate may be provided by carbon nanoparticles and the hydrophobic particles may be provided by polytetrafluoroethylene (PTFE) sub-micron sized particles.

With the adhesive of the double-sided adhesive film exposed, the side of the GDL carrying the MPL is overlaid on the film. The adhesive is then impregnated into the MPL by applying heat and pressure to the film and the GDL for a specified dwell time, in a process also referred to as hot pressing. Conveniently, the film and GDL are placed between two clean sheets of PTFE, or a similar material, and then hot pressed at between 30° C. and 300° C. under a pressure of between 0.01 bar and 50 bar for a dwell time of between 1 second and 600 seconds.

Hot pressing can be carried out through a heated calendaring roller, a heated reciprocal platen or similar apparatus.

With the adhesive of the film impregnated into the MPL and the bottom release liner in place, that is the release liner on the opposite or CCM side of the film, the GDL is cut to its net shape with the aid of the positioning pilot holes in the double-sided adhesive film assembly. The result is a GDL with an adhesive border impregnated into the MPL.

The bottom release liner is then removed from the film, which now forms the adhesive border of the GDL, to expose the adhesive. The gasketed CCM is then precisely positioned over the GDL with the adhesive border of the GDL surrounding the active area of the CCM and the GDL and CCM adhered together using pressure.

The same process is followed on the opposite side of the CCM to produce a resulting MEA. The adhesive from both GDL's can then be set onto the gasket of the CCM by placing the assembly between two sheets of PTFE or similar material and hot pressing at between 30° C. and 300° C. under a pressure of between 0.01 bar and 50 bar for between 1 second and 600 seconds. This hot pressing can also be carried out through a heated calendaring roller, a heated reciprocal platen or similar apparatus.

The above process provides a membrane electrode assembly (MEA) which includes a gas diffusion layer (GDL) and a gasketed catalyst coated membrane (CCM) having at least one gasket surrounding an active area of the CCM. The GDL is secured to the CCM by a double-sided adhesive film positioned intermediate the GDL and gasket. The MEA includes an anode GDL and a cathode GDL secured on opposite sides of a gasketed CCM with double-sided adhesive film securing each GDL to a gasket of the gasketed CCM.

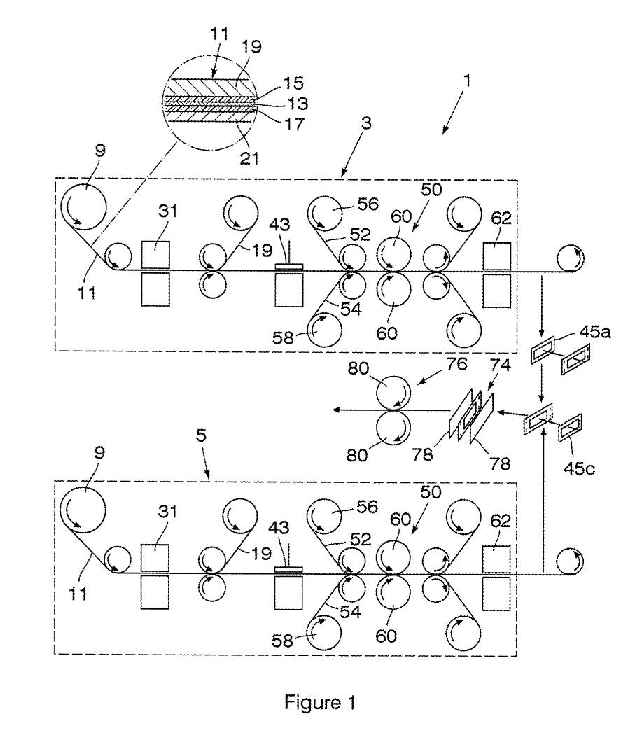

An apparatus (1) for producing an MEA in which an anode GDL and a cathode GDL are secured to a gasketed CCM through double-sided adhesive film is shown in FIG. 1 and includes an anode GDL station (3) and a cathode GDL station (5) (both denoted in broken lines) which operate in identical fashion. The same numerals will be used to refer to the same features in each station (3, 5). Each station (3, 5) has a feed spool (9) with an elongate sheet of double-sided adhesive film (11) wound on it. The film (11) has a layered structure with a central polyester carrier film (13) with an acrylic-based adhesive (15, 17) on both sides thereof and a top release liner (19) over the adhesive (15) on one side and a bottom release liner (21) over the adhesive (17) on the opposite side. In this embodiment the carrier film (13) and adhesive layers (15, 17) have a thickness of between about 0.005 mm and 0.020 mm. The film (11) is similar to the double-sided adhesive tape produced by the Teraoka Seisakusho Company Limited as 7070 0.01 W and which is typically used for securing LCD back light parts, reflection film, diffusion film and the like in place.

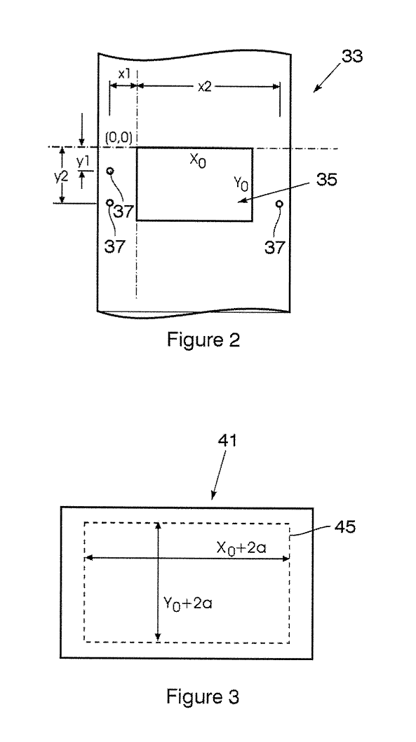

The film (11) is fed from the spool (9) to a cutting station (31) from which the pattern (33), shown in FIG. 2, is cut, in this embodiment by using a die. A frame shaped film pattern (33) is obtained, and repeated on the continuous film, as shown in FIG. 2 with a central opening (35) having the same dimensions as that of the active area of a CCM. The active area is defined by the dimensions x₀ and y₀. Pilot holes (37) are provided to facilitate precise positioning and cutting and their centres are defined in the x and y axes by x1, x2 and y1, y2 respectively.

In this embodiment the film pattern (33) is left attached to the continuous film (11). Sprocket holes (not shown) are spaced apart along the film's periphery for handling convenience.

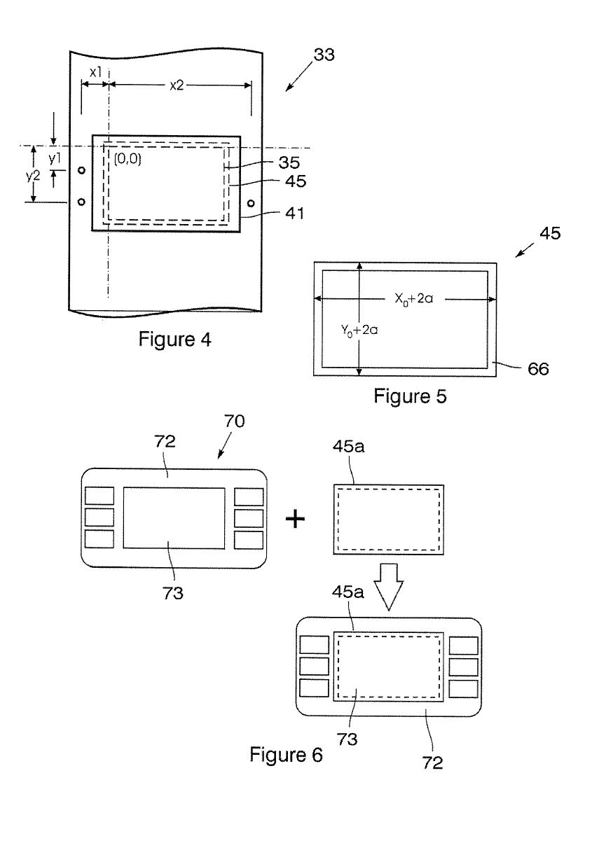

The top release liner (19) is then removed from the film to expose the adhesive (15). A GDL sheet (41), shown in FIG. 3, is then positioned and pressed at location (43) over the film pattern (33) using the pilot holes for location reference. Initial adhesion is obtained between the GDL sheet (41) the film as shown in FIG. 4.

The GDL sheet (41) is cut from a length of material (not shown) and has dimensions which are larger than the net shape GDL (45) (shown in broken lines). The net shape GDL (45) is the active area plus two times the GDL-to-gasket overlap (α). The dimensions of the net shape GDL are thus x₀+2α and y₀+2α.

A MPL is provided on one side of the GDL sheet (41) and it is this side which is applied to the adhesive (15) of the film pattern (33).

In order to impregnate the adhesive (15) into the MPL on the GDL sheet (41), a hot pressing step (50) is conducted. The GDL sheet (41) and attached film are fed between two sheets of PTFE (52, 54) which are continuously fed from spools (56, 58) and between a pair of heated calendaring rollers (60). The GDL sheet (41) and film are heated to 60° C. under a product pressure of 2 bar at a web speed of between 1 and 10 metres per minute.

Hereafter the net shape GDL (45) is cut out from the film pattern (33) using a punch die (62) which uses the pilot holes (37) as location reference. The resulting component is a net shape GDL (45) with an adhesive border (66) impregnated into the MPL and covered by the bottom release liner (21) as shown in FIG. 5. The adhesive border has a width of a mm while the overall dimensions of the net shape GDL (45) remain x₀+2α and y₀+2α.

The bottom release liner (21) is next removed from the adhesive border (66) on the net shape anode GDL (45a) to produce a net shape GDL with exposed adhesive (45a) as shown in FIG. 6. Referring also to FIG. 6, the net shape anode GDL (45a) is precisely positioned onto the anode side of a gasketed CCM (70) having a gasket (72) and adhered to it using light pressure around its perimeter. The cathode GDL (45c) has its release liner (21) removed and it is similarly adhered to the opposite, cathode side of the gasketed CCM (70). The resulting assembly is an MEA (74) in which the adhesive border (66) on each GDL is adhered to the gasket (72) and surrounding the MEA active area (73) equal to dimensions X₀ by Y₀. The adhesive (15, 17) is finally set onto the gasket (72) in a hot pressing step (76) in which the MEA (74) is placed between a pair of PTFE sheets (78) and fed between a pair of heated calendaring rollers (80). The MEA is heated to 60° C. under a product pressure of 2 bar at a feed rate of between 1 to 10 metres per minute whereafter it is ready for use in a fuel cell (not shown).

The method of securing a GDL to a CCM has a number of advantages over the prior art. The use of a solid adhesive film permits a high degree of accuracy to be consistently achieved with smaller tolerances than can be achieved with liquid adhesives. As the double-sided adhesive film can be cut using any suitable method, for example laser cutting or roller die cutting, and these are typically easy to modify, the same assembly line can easily be modified to accommodate different GDL and CCM dimensions and configurations.

The method provided by the current invention does not require the purchase of expensive liquid adhesive coating and curing equipment. It also has reduced lead times as mandatory cure times for liquid adhesives are unnecessary. Furthermore there is no need to subject the final gasketed MEA to liquid adhesive heat treatments that may compromise the physical properties of the gasket, for example by causing wrinkling, folding or bending. Importantly, the placement and adhesion of the GDL onto the gasketed CCM is instant and accomplished simultaneously. This removes the potential of subsequent misalignment during curing.

It will be appreciated that many other embodiments exist which fall within the scope of the invention. For example, any suitable double-sided adhesive film can be used and it need not be cut from a larger sheet. It could, for example, be provided by a suitable tape which is accurately positioned on the GDL or gasketed CCM. Also, the film could first be applied to the gasketed CCM and the GDL then adhered thereto. In this event a single hot pressing may suffice to both cure the adhesive to the gasket and impregnate it into the MPL. Depending on the components used, it may not be required to hot press the assembly at any stage.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of securing a gas diffusion layer to a catalyst coated membrane having a gasket surrounding an active area, which includes positioning a double-sided adhesive film intermediate the GDL and gasket and applying pressure to the GDL and gasket.

2. A method as claimed in claim 1 in which the double-sided adhesive film is pressure sensitive.

3. A method as claimed in claim 1 in which the double-sided adhesive film is frame shaped.

4. A method as claimed in claim 1 in which the double-sided adhesive film is removed from a sheet of material.

5. A method as claimed in claim 1 in which the double-sided adhesive film has a thickness of between 0.005 mm and 0.050 mm.

6. A method as claimed in claim 1 in which the double-sided adhesive film is supplied with a release liner covering the double-sided adhesive film on each side and in which each release liner is removed prior to placement of the double-sided adhesive film on the GDL and gasket respectively.

7. A method as claimed in claim 1 in which the double-sided adhesive film comprises adhesive that is carried on either side of a carrier film.

8. A method as claimed in claim 1 in which a microporous layer is provided on one side of the GDL and the double-sided adhesive film is applied over the MPL.

9. A method as claimed in claim 8 in which heat and pressure are applied to the GDL and the double-sided adhesive film to cause the double-sided adhesive film to be impregnated into the MPL.

10. A membrane electrode assembly which includes a gas diffusion layer and a catalyst coated membrane having a gasket surrounding an active area of the CCM, and characterised in that the GDL is secured to the CCM by a double-sided adhesive film positioned intermediate the GDL and gasket.

11. An MEA as claimed in claim 10 including an anode GDL and a cathode GDL secured on opposite sides of the CCM with the double-sided adhesive film securing each GDL to a gasket of the CCM.

12. An MEA as claimed in claim 10 in which the double-sided adhesive film is provided by a carrier film having an adhesive layer on each side.

13. An MEA as claimed in claim 10 in which the double-sided adhesive film has a thickness of between 0.005 mm and 0.050 mm.

14. An MEA as claimed in claim 10 in which a microporous layer (MPL) is provided on one side of each GDL and wherein the adhesive film is applied to the MPL.
